(19) United States
(12) Patent Application Publication
(10) Pub. No.: US 2006/0031672 A1
(43) Pub. Date: Feb. 9, 2006

(54) Resource protection in a computer system with direct hardware resource access

(76) Inventors: Donald C. Soltis JR., Fort Collins, CO (US); Rohit Bhatia, Fort Collins, CO (US); Eric R. DeLano, Fort Collins, CO (US); Bill Greene, Fort Collins, CO (US); Amy Santoni, Ann Arbor, MI (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/910,630

(22) Filed: Aug. 3, 2004

(51) Int. Cl. H04L 9/00

(52) U.S. Cl. 713/164

(57) ABSTRACT

In one embodiment of the present invention, a computer-implemented method is provided for use in a computer system including a plurality of resources. The plurality of resources include protected resources and unprotected resources. The unprotected resources include critical resources and non-critical resources. The method includes steps of: (A) receiving a request from a software program to access a specified one of the unprotected resources; (B) granting the request if the computer system is operating in a non-protected mode of operation; and (C) if the computer system is operating in a protected mode of operation, performing a step of denying the request if the computer system is not operating in a protected diagnostic mode of operation.

### CROSS REFERENCE TO RELATED APPLICATIONS

This application is related to a concurrently-filed and commonly-owned U.S. patent application entitled “Computer System Resource Access Control,” Attorney Docket No. 200311229-1, which is hereby incorporated by reference.

### BACKGROUND

The present invention relates to computer architecture and, more particularly, to techniques for controlling access to resources in a computer system.

### RELATED ART

Computers include a variety of resources, including memory (e.g., ROM and RAM), processor registers, and input/output devices. In early computer architectures, any program executing on a computer could access any resource without limitation. For example, any program, whether it be an operating system, device driver, or application program, could read and write values to any memory location. Although such computer architectures had the advantage of being relatively simple to design and implement, they had the disadvantage that a poorly-designed or malicious program could cause the computer to malfunction by modifying a resource in an inappropriate way. For example, an application program could inadvertently or maliciously modify data relied upon by the operating system and thereby cause the operating system to malfunction or crash. As another example, a first application program could overwrite data in use by a second application program, thereby causing the second application program to malfunction or crash.

One technique that has been employed to address this problem is to provide each software program executing on a computer with a particular set of resource access rights (also referred to as “privileges”). A particular application program may, for example, have the right to access a particular subset of main memory and a particular set of I/O devices. Another application program may have the right to access a different subset of main memory and a different set of I/O devices. The operating system typically has the right to access all resources.

A resource access control mechanism, which may be implemented in hardware and/or software, is provided for enforcing these access rights. When a particular program requests that a particular operation be performed on a particular resource, the access control mechanism determines whether the program has the right to perform the requested operation on the specified resource. If the program does have such a right, the access control mechanism allows the requested operation to proceed. Otherwise, the access control mechanism denies the request and typically generates a fault.

In a particular computer system, there may be a large number of resources and a large variety of access rights that can be associated with each resource (such as the right to read from the resource, write to the resource, and execute software on the resource). Instead of allowing each program to be assigned an individually-configurable set of access rights, most systems define a set of “privilege levels,” each of which is associated with a particular set of access rights. Each program is then assigned one of the predefined privilege levels, thereby granting to the program the set of access rights associated with the assigned privilege level.

Consider a simple example of a computer system which has two privilege levels: (1) a most-privileged level (sometimes referred to as the “kernel privilege level”); and (2) a less-privileged level (sometimes referred to as the “application program privilege level”). Programs executing at the kernel privilege level may have the right to perform all operations on all resources, while programs executing at the application program privilege level typically have the right to execute only instructions within a certain subset of the processor's instruction set and to access only a subset of the computer's memory. In such a system, the operating system typically is assigned the kernel privilege level, while application programs typically are assigned the application program privilege level. The use of privilege levels makes it possible to assign and identify the access rights granted to a particular program by reference to the program's privilege level, without the need to assign and identify individual access rights on a program-by-program basis. The use of privilege levels is described in more detail in the commonly-owned patent application entitled “Method and System for Privilege-Level-Access to Memory Within a Computer,” Pub. No. U.S. 2003/0084256 A1, published on May 1, 2003, hereby incorporated by reference.

There may be any number of privilege levels in a computer system. Typically, privilege levels are numbered sequentially beginning with zero. Consider, for example, a system in which there are four privilege levels, numbered from zero through three. Privilege level zero typically is the most-privileged level. The operating system typically has privilege level zero. Intermediate privilege levels (such as privilege levels 1 and 2) may be granted to device drivers and other software programs which require a relatively high degree of access to a subset of the computer's resources. The least-privileged level (e.g., privilege level 3) typically is assigned to application programs.

Computer systems which implement resource access control rights, such as through the use of privilege levels, thereby prevent programs from accessing resources in ways which might cause the system to malfunction. As computer architectures continue to evolve, however, the techniques described above may be insufficient to provide the necessary kind and degree of resource access control for all resources in a computer system. What is needed, therefore, are improved techniques for controlling access to resources in a computer system.

### SUMMARY

In one embodiment of the present invention, a computer-implemented method is provided for use in a computer system including a plurality of resources. The plurality of resources include protected resources and unprotected resources. The unprotected resources include critical resources and non-critical resources. The method includes steps of: (A) receiving a request from a software program to access a specified one of the unprotected resources; (B) granting the request if the computer system is operating in a non-protected mode of operation; and (C) if the computer system is operating in a protected mode of operation, performing a step of denying the request if the computer system is not operating in a protected diagnostic mode of operation.

Other features and advantages of various aspects and embodiments of the present invention will become apparent from the following description and from the claims.

### BRIEF DESCRIPTION OF THE DRAWINGS

FIG. 1 is a block diagram of a prior art computer system including a hardware layer, an operating system layer, and an application layer;

FIG. 2A is a block diagram of a prior art computer system including a hardware layer, a hardware interface layer, an operating system layer, and an application layer;

FIG. 2B is a block diagram of a computer system including protected resources and unprotected resources according to one embodiment of the present invention;

FIG. 2C is a block diagram of a computer system including critical resources and non-critical resources according to one embodiment of the present invention;

FIG. 3 is a flowchart of a method that is performed in one embodiment of the present invention to set the value of a protected mode indicator and a protected diagnostic mode indicator according to one embodiment of the present invention;

FIG. 4 is a dataflow diagram illustrating the actions performed by the hardware interface layer of FIG. 2B to perform the method of FIG. 3 according to one embodiment of the present invention;

FIG. 5 is a flowchart of a method for processing resource access requests according to one embodiment of the present invention; and

FIG. 6 is a block diagram illustrating the actions performed by the hardware interface layer of FIG. 2B to perform the method of FIG. 5 according to one embodiment of the present invention.

### DETAILED DESCRIPTION

Techniques are disclosed for controlling access to critical resources in a computer system. The computer system may include a plurality of resources, including both protected and unprotected resources. The unprotected resources may include both critical and non-critical resources. The computer system may operate in a non-protected mode, a protected diagnostic mode, or a protected non-diagnostic mode of operation. When the computer system operates in the non-protected mode, a diagnostic tool may access the unprotected resources without restriction. When the computer system operates in protected diagnostic mode, the diagnostic tool may also access the unprotected resources without restriction. When the computer operates in protected non-diagnostic mode, however, access by the diagnostic tool to the critical resources is restricted. In such a mode, the diagnostic tool may be prohibited from performing any operations on the critical resources, or may be allowed only to perform operations of allowed types on the critical resources.

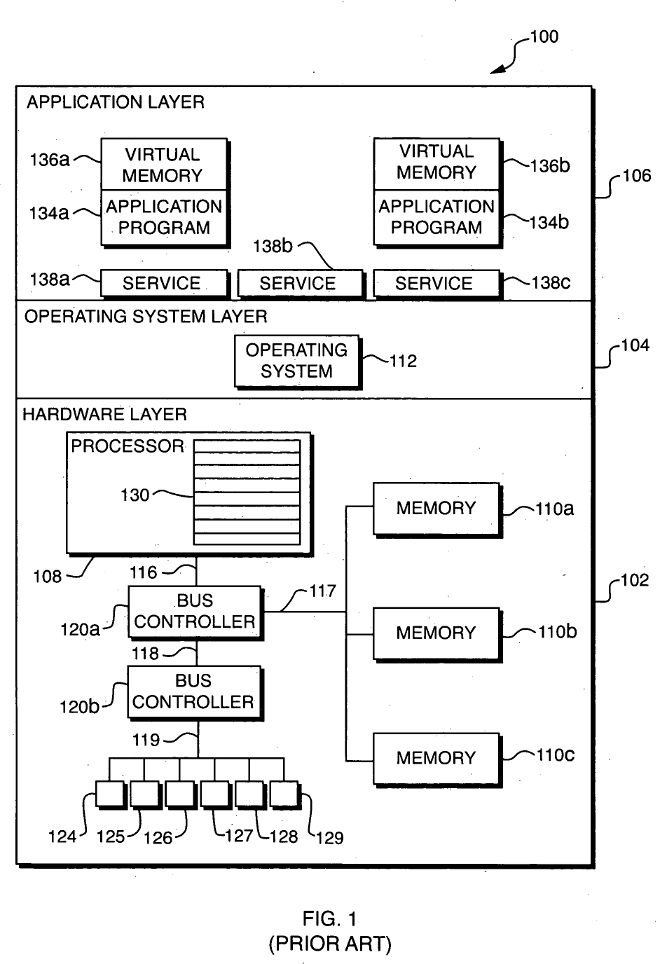

Referring to FIG. 1, a block diagram is shown of a prior art computer system 100. The computer system 100 includes a hardware layer 102, an operating system layer 104, and an application program layer 106. The operating system and application programs in the computer system 100 execute on hardware in the hardware layer 102. The “layers” 104 and 106 illustrated in FIG. 1 do not, therefore, represent physical layers of components which are physically layered on top of the hardware layer 102. Rather, the computer system 100 is illustrated as consisting of layers 102, 104, and 106 as an aid to explaining the interactions among hardware and software in the computer system 100. In particular, it is common to conceptualize and illustrate computer systems in terms of such layers to highlight the dependence of elements at a higher layer on elements at lower layers, and to illustrate the flow of control and data among layers.

The hardware layer 102 comprises the physical components of the computer system 100. Such physical components may include, for example, a processor 108, memory storage components 110a-c, internal buses and signal lines 116-119, bus controllers 120a-b, and various peripheral interface cards 124-129. The processor 108 is an instruction-execution device that executes a stream of instructions obtained from memory components 110a-c. The processor 108 contains internal memory storage components referred to as registers 130 that can be accessed much more quickly than the memory components 110a-c. The processor 108 reads and writes data and instructions from and to the memory components 110a-c via internal buses 116 and 117 and the bus controller 120a. Far greater data storage capacity resides in peripheral data storage devices such as disk drives, CD-ROM drives, DVD drives, and other such components that are accessed by the processor 108 via internal buses 116, 118, and 119, bus controllers 120a-b, and one or more of the peripheral device interconnect cards 124-129. For example, the stored instructions of a large program may reside on a disk drive for retrieval and storage in memory components 110a-c on an as-needed basis during execution of the program. More sophisticated computers may include multiple processors with correspondingly more complex internal bus interconnections and additional components.

The operating system layer 104 is a logical layer which includes a software program 112 referred to as an operating system, which is capable of controlling the hardware components in the hardware layer 102. Modern operating systems are relatively large and complex, typically consisting of a large number of sub-programs executing concurrently. At its core, however, the operating system 112 includes program code which may be utilized by application programs to cause the hardware components in the hardware layer 102 to perform functions such as reading from and writing to memory and peripheral devices.

The application programming layer 106 includes one or more application programs. Two application programs 134a-b illustrated in FIG. 1 for ease of illustration and explanation. The operating system 112 allocates virtual memory regions 136a-b to application programs 134a-b, respectively. Note that the virtual memory regions 136a-b are not additional regions of physical memory, but rather are logical regions which are mapped to memory locations in the memory components 110a-c. Requests by the application programs 134a-b to access the corresponding virtual memory regions 136a-b are passed through the operating system 112, which performs the requested read/write operation on the appropriate location(s) in the memory components 110a-c. In addition, the operating system 112 denies any request by the application programs 134a-b to access memory addresses outside of their respective virtual memory regions 136a-b, thereby providing a degree of resource access control.

One way in which the application programs 134a-b may be restricted to accessing memory in the corresponding virtual memory regions 136a-b is by using the privilege-based access control techniques described above. For example, a most-privileged privilege level may be assigned to the operating system 112, while a less-privileged privilege level may be assigned to both of the application programs 134a-b. The operating system 112, due to its most-privileged status, may access any memory location in the memory components 110a-c. The application programs 134a-b, in contrast, due to their less-privileged status, may be denied the ability to execute processor instructions which directly access the memory storage components 110a-c. The application programs 134a-b may, therefore, only access memory components 110a-c indirectly through the operating system 112, which may refuse to process requests by the application programs 134a-b to access memory locations outside of their respective virtual memory regions 136a-b. Typically, an operating system indicates in hardware the access rights of the virtual memory sections, thereby allowing the hardware to grant or refuse access to privileged resources.

The application layer 106 may include a variety of services 138a-c, provided by the operating system 112, through which the application programs 134a-b may communicate with the operating system 112. Such services 138a-c may, for example, enable the application programs 134a-b to perform operations such as writing data to and retrieving data from external devices, or accessing system information (such as an internal clock or system configuration information).

Although in the description above multiple programs are described as executing concurrently, in a single-processor computer system such as the system 100 illustrated in FIG. 1, only one process executes on the processor 108 at a time. Concurrent program execution may be simulated by causing the processor 108 to alternate between executing instructions from the first program 134a and the second program 134b. The operating system 104 typically manages such “multithreading” by retrieving a subset of instructions from the first program 134a, executing those instructions on the processor 108, retrieving a subset of instructions from the second program 134b, executing those instructions on the processor 108, and so on. Various techniques are well-known to those having ordinary skill in the art for implementing operating systems which manage such multithreading in efficient ways.

It is important in such systems that the privilege level associated with each program be enforced while instructions from that program are executing on the processor 108. In some systems such enforcement is performed by including a processor status register in the register file 130. The processor status register includes one or more bits which specify the privilege level of the currently-executing program. Such bits are referred to herein as “current privilege level” (CPL) bits. In a system which recognizes two privilege levels, for example, a single CPL bit may be used, in which a value of zero represents a most-privileged level and a value of one represents a less-privileged level.

In such systems, the hardware layer 102 controls access to the CPL bits. For less-privileged code to perform a more-privileged operation, the less-privileged code (such as code in the application programs 134a-b) must trigger a fault or trap through the hardware layer 102 to the operating system layer 104. In response, the hardware layer 102 sets the value of the CPL bits to indicate the more-privileged privilege level, and transfers control to more-privileged code to perform some operation on behalf of the less-privileged code. It should be appreciated from this description that software programs, such as the operating system 112, which have the most-privileged privilege level, may perform operations requiring any privilege level (including the most-privileged level) on behalf of less-privileged code. The more-privileged code may then execute a return-from-interruption instruction, which restores the less-privileged value of the CPL bits before returning control to the less-privileged code.

Consider, for example, the execution of instructions in one of the application programs 134a-b by the operating system 112. Before executing instructions from one of the application programs 134a-b, the operating system 112 may set the value of the CPL bit to one (using a return from interruption instruction), representing the less-privileged (application program) privilege level. The operating system 112 may then initiate execution of the application program instructions, which will execute with the resource access restrictions associated with the application program privilege level. Prior to executing system management operations (such as operations which manipulate the contents of control registers and operating-specific data structures), the operating system 112 may use a hardware fault or trap to set the value of the CPL bit to zero, representing the most-privileged (kernel) privilege level. The operating system 112 may then perform the desired system management functions, after which the hardware layer 102, at the request of the operating system, may restore the current privilege level to the privilege level of the application program. In this way the operating system 112 may perform operations with full access to all system resources, while the applications programs 134a-b are provided with limited access to system resources.

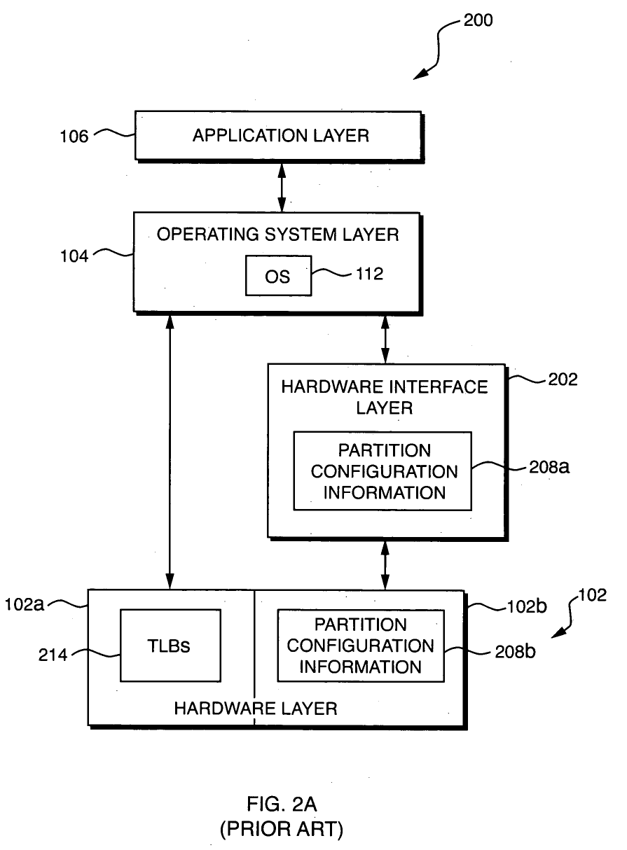

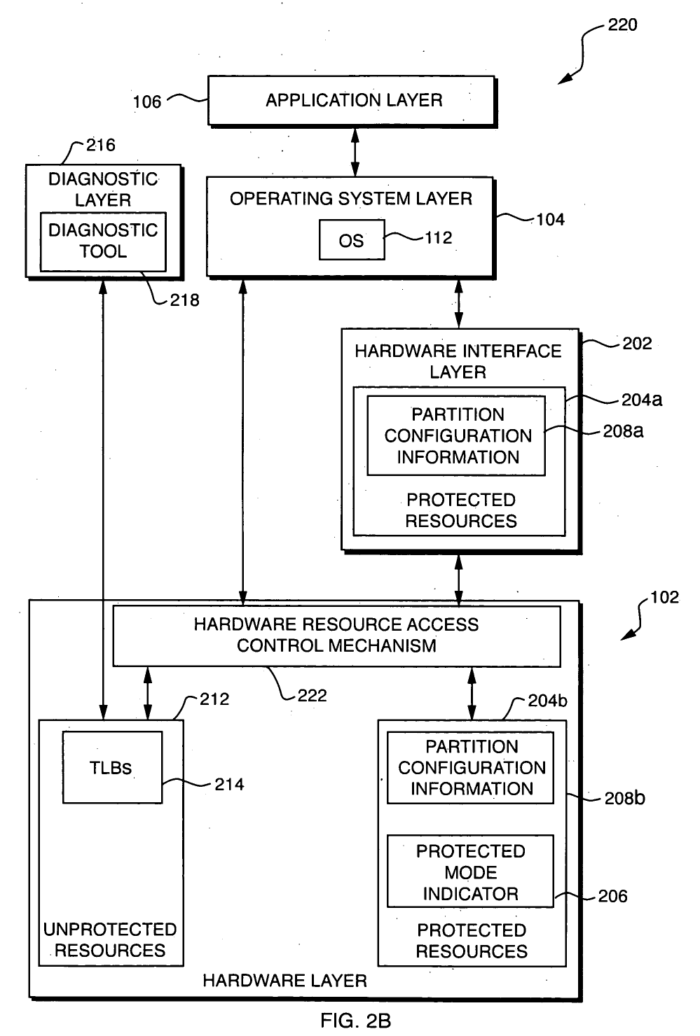

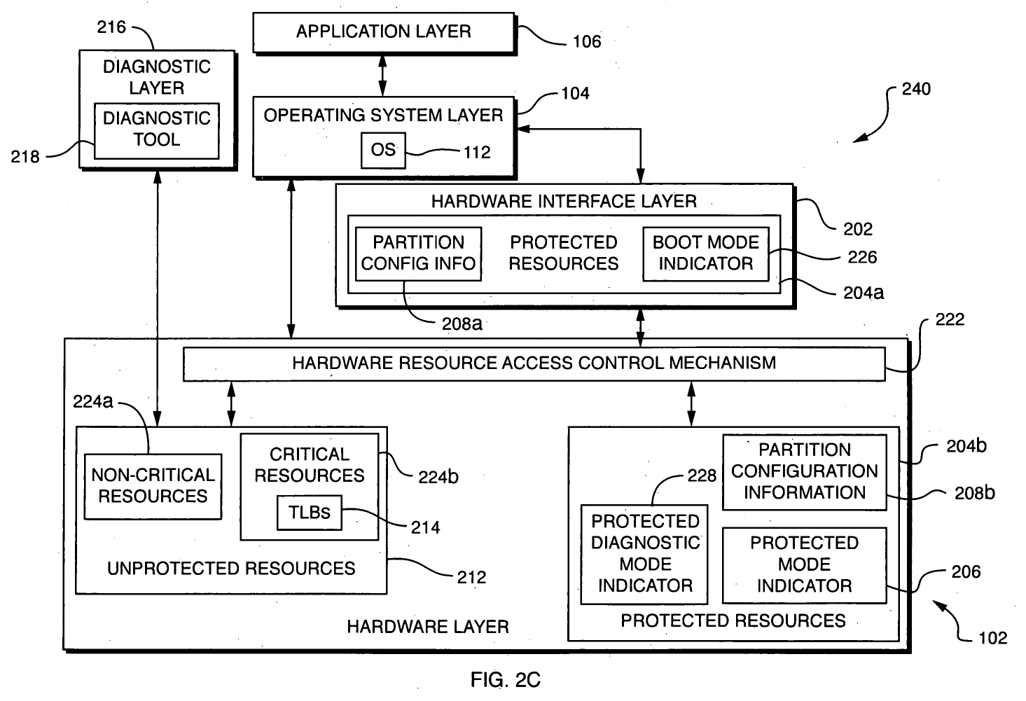

Although the computer system illustrated in FIG. 1 includes three layers 102, 104, and 106, some modern computer architectures include additional layers. Referring to FIG. 2A, for example, a computer system 200 is shown which includes hardware layer 102, operating system layer, application layer 106, and a hardware interface layer 202 interposed between the hardware layer 102 and the operating system layer 104. The hardware interface layer 202, as its name suggests, acts as an interface between the operating system layer 104 and the hardware layer 102. The hardware interface layer 202 may include hardware, software, firmware, or any combination thereof.

One purpose of the hardware interface layer 202 may be to provide a single abstract interface through which the operating system layer 104 may communicate with the processor 108 and other components in the hardware layer 102, regardless of the particular manner in which such components are implemented. The hardware interface layer 202 thereby enables the processor 108 and other hardware components to be implemented in a variety of ways without modifying the operating system layer 104 or the application layer 106. As a result, designers of the components in the hardware layer 102 have greater flexibility and designers of the operating system 112 and application programs 134a-b need not take implementation details of the hardware layer 102 into account when designing the operating system 112 and application programs 134a-b. As a result, the time and cost required to develop the operating system 112, the application programs 134a-b, and the hardware components in the hardware layer 102 may be reduced.

The Intel® Itanium® Architecture, for example, defines a Processor Abstraction Layer (PAL) and a System Abstraction Layer (SAL). In one embodiment of the present invention, the hardware interface layer 202 includes a PAL and a SAL. The PAL is defined in Volume 2, Chapter 11 of the “Intel® Itanium® Architecture Software Developer's Manual,” Revision 2.1 (October 2002), hereby incorporated by reference. The SAL is defined in the “Itanium® Processor Family System Abstraction Layer Specification” (November 2002) and the corresponding “Intel® Itanium® Processor Family System Abstraction Layer Specification Update” (January 2003), both of which are hereby incorporated by reference.

In general, the PAL provides an abstract interface (implemented in firmware) between software programs (such as the operating system 112 and application programs 134a-b) and the processor 108, so as to maintain a single software interface for multiple implementations of the processor 108. The PAL encapsulates those processor functions that are likely to be implemented in different ways in different processor implementations, so that the operating system 112 can maintain a consistent view of the processor 108. These functions include non-performance critical functions such as processor initialization, configuration, and error handling. The PAL consists of two main components. The first is a set of interruption entry points, which are invoked directly by hardware events such as reset, init, and machine checks. These interruption entry points perform functions such as processor initialization and error recovery. The second PAL component is a set of procedures, which may be called by higher-level firmware (such as the SAL, described below) and software: (1) to obtain information about the identification, configuration, and capabilities of the processor 108; (2) to perform implementation-dependent functions such as cache initialization; and (3) to allow software (e.g., the operating system 112 and application programs 134a-b) to interact with the hardware layer 102 through such functions as power management and enabling/disabling of processor features.

The SAL performs functions similar to those performed by the PAL, except that the SAL provides a firmware interface to the platform of the computer system 220. The term “platform” refers to components in the hardware layer 102 including the processor 108, buses 116-119, and memory 110a-c. The SAL does not interact directly with the processor 108, but rather, like the operating system 112, interacts with the processor 108 through the PAL.

Another function that may be performed by the hardware interface layer 202 is the establishment and maintenance of multiple “partitions” in a partitionable computer system. The term “partitionable computer system” refers to a computer system which may be logically subdivided into multiple “partitions,” each of which is allocated a portion of the computer's resources. For example, each partition may be allocated a particular processor and portion of main memory. Furthermore, each partition may execute its own operating system and software applications, and otherwise act similarly to an independent physical computer. A single partitionable computer system may, therefore, provide the same functionality as a plurality of distinct physical computers.

The hardware interface layer 202 may allocate resources to partitions and ensure that software programs are only able to access resources within their own partitions. Ideally, conventional operating systems and application programs which are designed to execute in non-partitioned computer systems may also execute without modification in a partition of a partitionable computer system. The hardware interface layer 202 may intercept all resource access requests issued by the operating system in a particular partition, identify the resource (e.g., memory location) addressed by the request, satisfy the request using the allocated resource, and return the results to the operating system.

To perform such partition management, and resource management more generally, the system 200 may include partition configuration information 208a-b. Such information 208a-b may include, for example, a table which specifies the resources (e.g., processors, memory, I/O ports) which are allocated to each partition. The hardware interface layer 202 may access such information 208a-b when processing resource access requests issued by the operating system layer 104.

Note that in the particular system 200 illustrated in FIG. 2A, a first portion 208a of the partition configuration information is contained in the hardware interface layer 202, while a second portion 208b of the partition configuration information is contained in the hardware layer 102. Note further that in the system 200 illustrated in FIG. 2A, the operating system layer 104 may only access the partition configuration information 208a-b through the hardware interface layer 202. The hardware interface layer 202 may, for example, verify that the operating system layer 104 has a sufficiently high privilege level to access the partition configuration information 208a-b.

The hardware layer 102 is illustrated in FIG. 2A includes both unprotected resources 212 and protected resources 204b. As just described, the operating system layer 104 may only access the protected resources 204b (such as the partition configuration information 208b) through the hardware interface layer 202. The operating system layer 104 may, however, access the unprotected resources without going through the hardware interface layer 202. Translation lookaside buffers (TLBs) 214 are one example of unprotected resources 212 in the hardware layer 102 which may be accessed by the operating system 104 without going through the hardware interface layer 202.

The partition configuration information 208a-b and other information maintained by the hardware layer 102 and the hardware interface layer 202 may be stored, for example, in registers, on-board memory, or in portions of the main memory 110a-c. It may be desirable for such information 204a-b to be accessible to the hardware layer 102 and to the hardware interface layer 202, but not to the operating system 112 or to the application programs 134a-b. Recall, however, that the operating system 112 typically has the most-privileged privilege level, according to which the operating system 112 has access to all system resources. If some or all of the partition configuration information 208a-b, however, is stored in memory components 110a-c or another resource accessible to the operating system 112, the operating system 112 would be able to modify such information 208a-b if the techniques disclosed above were employed. Examples of techniques will now be described for protecting resources, such as the partition configuration information 208a-b, against being accessed even by software programs having the most-privileged privilege level.

Referring to FIG. 2B, a diagram is shown of a computer system 220 according to one embodiment of the present invention. The computer system 226, like the computer system 200 shown in FIG. 2A, includes hardware layer 102, hardware interface layer 202, operating system layer 104, and application layer 106. The system 220 also includes protected resources 204a-b. In particular, the hardware interface layer 202 of computer system 220 includes protected resources 204a, while the hardware layer 102 of computer system 220 includes protected resources 204b. In the embodiment illustrated in FIG. 2B, the protected resources 204a and 204b include partition configuration information 208a and 208b, respectively. In addition, the protected resources 204b include a protected mode indicator 206. As described in more detail in the above-referenced patent application entitled “Computer System Resource Access Control,” the computer system 220 may operate in a protected mode in which software in the operating system layer 104 and application layer 106 is prevented from accessing the protected resources 204a-b, even if the software has the most-privileged privilege level.

The hardware layer 102 also includes unprotected resources 212. Examples of the unprotected resources 212 include translation lookaside buffers 214, caches, and other array structures. As shown in FIG. 2B, the hardware layer 102 includes a hardware resource access control mechanism 222 which controls access by software programs in the application layer 106 and the operating system layer 104 to both the unprotected resources 212 and the protected resources 204b. In other words, any request by a program in the application layer 106 or the operating system layer 104 to access resources 212 or 204b in the hardware layer 102 must be processed by the hardware resource access control mechanism 222, whether such a request is made directly to the hardware layer 102 or indirectly through the hardware interface layer 202. Operation of the hardware resource access control mechanism 222 is described in more detail in the above-referenced patent application entitled “Computer System Resource Access Control.”

As one example, when an application in the application layer 106 issues a conventional “load” or “store” operation to read or write a memory location, such an operation is checked by the hardware resource access control mechanism 222 to determine whether the application has sufficient access privileges to read or write the specified memory location. If the application does not have sufficient access privileges, the hardware resource access control mechanism 222 denies the request. This is one means by which the resources 212 and 204b in the hardware layer 102 are protected against unauthorized access.

As further described in the above-referenced patent application entitled “Computer System Resource Access Control,” the computer system 220 may operate in either a protected mode of operation or an unprotected mode of operation. Requests to access the protected resources 204b are handled differently depending on whether the computer system 220 is operating in the protected mode or the unprotected mode of operation. The protected mode indicator 206 indicates whether the computer system 220 is to operate in the protected mode of operation. The protected mode indicator 206 may, for example, be implemented in one or more bits in a register (such as the processor status register (PSR)) in the hardware layer 202. Assume for purposes of the following discussion that the protected mode indicator 206 is a one-bit value PM, that when PM=0 the computer system 220 operates in non-protected mode, and that when PM=1 the computer system 220 operates in protected mode. When the computer system 220 operates in non-protected mode, software (e.g., the operating system 112) having the most-privileged privilege level is given unrestricted access to all resources, including the protected resources 204a-b.

When the computer system 220 operates in protected mode, access to protected resources 204a-b by all software at all privilege levels is denied. As described in the above-referenced patent application entitled “Computer System Resource Access Control,” the value of the protected mode indicator 206 may only be modified by a hardware fault to the hardware interface layer 202 (e.g., the PAL). Neither the operating system 112 nor any other software program may modify the value of the protected mode indicator 206, regardless of the privilege level of the software program. This guarantees that only the hardware interface layer 202 (e.g., the PAL) can obtain and grant access to the protected resources 204a-b. The value of the protected mode indicator 206 may be restored to its previous value (e.g., 1) upon a return from such a hardware fault.

The use of the protected mode of operation in the manner just described may, however, leave open a security hole in the computer system 220. As shown in FIG. 2B, the computer system 220 also includes a diagnostic layer 216, which includes a diagnostic tool 218. The diagnostic tool 218 may, for example, be a software program which may be used to perform diagnostic operations on the computer system 220, such as checking the integrity of the memory, checking for failures in caches, TLBs, register files, etc. The diagnostic layer 216 is illustrated in parallel with the operating system layer 104 to indicate that the diagnostic layer 216 may be loaded at bootup instead of the operating system layer 104. Typically, as described in more detail below, the user of the system 220 is provided with a choice at bootup whether to boot into the diagnostic layer 216 or the operating system layer 104. If the user chooses to boot into the diagnostic layer 216, the diagnostic tool 218 is loaded, and the user may use the diagnostic tool to perform diagnostic operations. Upon completion of such operations, the diagnostic tool 218 may be unloaded, and the operating system 112 loaded, and the computer system 220 then restarted with the operating system 112 executing.

The diagnostic tool 218, unlike the operating system 112, is provided with direct access to the unprotected resources 212 through the use of “hardware-specific methods” (also referred to as “diagnose operations”) which bypass the normal mechanisms by which the operating system 112 and other programs access resources in the hardware layer 102. Examples of such methods include a “hardware load” and “hardware store” which, unlike conventional “load” and “store” operations, directly read from and write to the unprotected resources 212 without passing through the access control mechanism 222. It is beneficial to provide the diagnostic tool 218 with such direct access to enable the diagnostic tool 218 to perform diagnostic operations (such as checking the integrity of a cache) which are not possible to perform using conventional operations, due to abstractions which are introduced by the access control mechanism 222 and the hardware interface layer 202. The diagnostic operations performed by the diagnostic tool 218 may, for example, bypass the error correction circuitry to operate directly on caches and other memory arrays.

Although hardware-specific methods are beneficial for the purpose of performing diagnostic operations, such methods potentially create a security hole in the system's mechanism for controlling access to resources in the hardware layer 102. More specifically, neither conventional privilege-based access controls nor the techniques disclosed above for protecting access to the protected resources 204b protect the unprotected resources 212 against access by the diagnostic layer 216 for the reasons just described. Examples of techniques will now be described for protecting the unprotected resources 212 against access by the diagnostic layer 216 or by any other component in the computer system 220 from which protection is desired.

In one embodiment of the present invention, requests by the diagnostic tool 218 to access the unprotected resources 212 are not granted in all circumstances, unlike in the system of FIG. 2B. Rather, the system 220 is provided with additional modes of operation through which an additional degree of control is provided over access to the unprotected resources 212. Referring to FIG. 2C, a diagram is shown of a computer system 240 according to one embodiment of the present invention in which the unprotected resources 212 include non-critical resources 224a and critical resources 224b. In the example illustrated in FIG. 2C, the critical resources 224b include translation lookaside buffers 214. As will now be described in more detail, embodiments of the present invention enable critical resources 224b to be protected against access by the diagnostic layer 216.

In the computer system 240 shown in FIG. 2C, the protected resources 204a-b additionally include a boot mode indicator 226 (in the hardware interface layer 202) and a protected diagnostic mode indicator 228 (in the hardware layer 102). The boot mode indicator 226 indicates whether the computer system 240 is to load the diagnostic layer 216 or the operating system layer 104 at system reset. The computer system 240 is said to operate in “diagnostic mode” when the diagnostic layer 216 is loaded, and to operate in “operating system” mode when the operating system layer 104 is loaded.

The protected diagnostic mode indicator 228, which is only applicable when the computer system 240 is operating in protected mode, indicates whether the computer system 240 should operate in a protected diagnostic mode or a protected non-diagnostic mode. The protected diagnostic mode indicator 228, like the protected mode indicator 206, may be implemented in one or more bits in a register (such as the processor status register (PSR)) in the hardware interface layer 202.

In one embodiment of the present invention, therefore, the computer system 240 of FIG. 2C may operate at any time in one of three modes of operation: non-protected mode, protected diagnostic mode, and protected non-diagnostic mode. In other words, the “protected mode” described above may have two sub-modes: protected diagnostic mode and protected non-diagnostic mode. The diagnostic tool 218 is granted access to the non-critical resources 224a in all three modes of operation. When the computer system 240 operates in non-protected mode, all requests by the diagnostic tool 218 to access unprotected resources 212 (including both the non-critical resources 224a and the critical resources 224b) are granted. Similarly, when the computer system 240 operates in protected diagnostic mode, requests by the diagnostic tool 218 to access unprotected resources 212 (including both the non-critical resources 224a and the critical resources 224b) are granted. When, however, the computer system 240 operates in protected non-diagnostic mode, requests by the diagnostic tool 218 to access the critical resources 224b are denied or otherwise restricted.

Note that the difference between protected diagnostic mode and protected non-diagnostic mode is that some resources (e.g., the critical resources 224b) are not protected against access by the diagnostic tool 218 in the protected diagnostic mode, while the same resources are protected against access by the diagnostic tool 218 in the protected non-diagnostic mode. The use of the three above-mentioned modes therefore effectively creates three classes of resources: non-protected, protected, and non-diagnostic protected. In the example illustrated in FIG. 2C, the non-critical resources 224a are examples of non-protected resources, the protected resources 204b are examples of protected resources, and the critical resources 224b are examples of non-diagnostic protected resources. The non-diagnostic protected resources are protected in protected non-diagnostic mode and not protected in protected diagnostic mode. Examples of techniques will now be described for implementing the above-described modes of operation in the computer system 240.

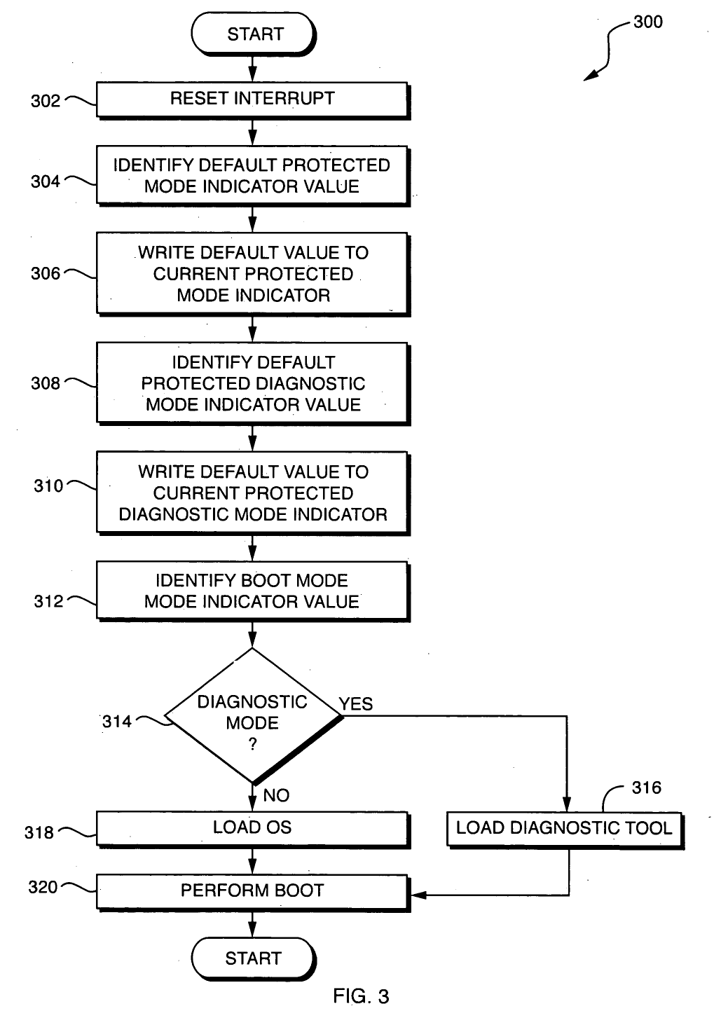

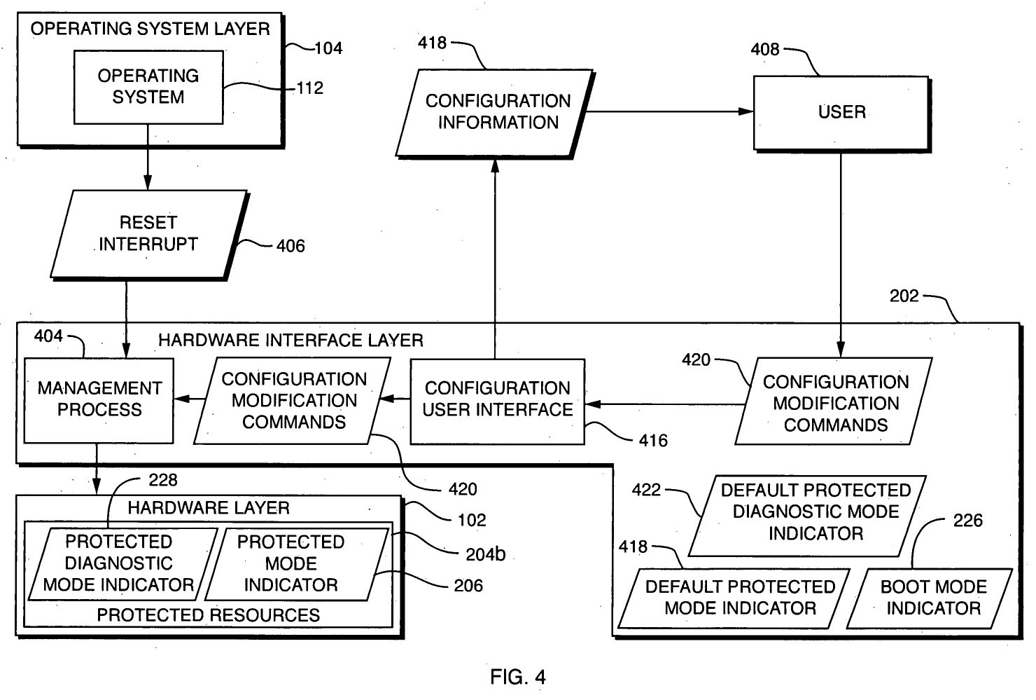

Referring to FIG. 3, a flowchart is shown of a method 300 that is performed by the hardware interface layer 202 and the hardware layer 102 to set the value of the protected mode indicator 206 and the protected diagnostic mode indicator 228 according to one embodiment of the present invention. Referring to FIG. 4, a dataflow diagram is shown illustrating the actions performed by the hardware interface layer 202 and the hardware layer 102 to execute the method 300 according to one embodiment of the present invention.

The method 300 may, for example, be performed by a management process 404 executing in the hardware interface layer 202. The management process 404 may, for example, be a part of the SAL which is authorized by the hardware layer 102 to access the protected resources 204a-b. Although only the single hardware interface layer 202 is shown in FIGS. 2B and 4, the hardware interface layer 202 may be further subdivided into additional layers, such as a PAL and a SAL, in which case the management process 404 may reside in the SAL and make requests to the PAL for access to the protected resources 204.

The method 300 is triggered by a reset interrupt 406 which may, for example, be generated by the operating system 112 upon system startup (step 302). The reset method 300 may be implemented as an interrupt service routine having a known entry point in the hardware interface layer 202. The reset interrupt 406 may, for example, be generated to perform a cold boot, warm boot, or other kind of reset of the computer system 220. The method 300 may also be performed, for example, after unloading the operating system currently executing on the computer system 220.

The hardware interface layer 202 includes default protected mode indicator 418, which stores a default value for the protected mode indicator 206. The defaulted protected mode indicator 418 may be stored in a persistent or semi-persistent storage medium such as CMOS or flash RAM. The value of the default protected mode indicator 418 may initially be set at the time of manufacture. The management process 404 may also allow the user 408 to modify the value of the default protected mode indicator 418 during and/or after the reset process. Upon powering up the computer system 220, for example, the management process 404 may present the user 408 with a configuration user interface (UI) 416 which displays the current value of configuration information such as the default protected mode indicator 418. The user 408 may provide configuration modification commands 420 to the management process 404 through the configuration UI 416, thereby instructing the management process 404 to modify the value of the default protected mode indicator 418. The default protected mode indicator 418 may retain this value until next modified by the user 408.

Returning to FIG. 3, the method 300 identifies the default value of the protected mode indicator 206 (step 304). The management process 404 may identify this value by reading it from the default protected mode indicator 418. Alternatively, the value of the default protected mode indicator 418 may be hard-coded into the management process 404. For example, the management process 404 may be hard-coded with a default protected mode indicator value of zero, in which case the management process 404 may identify a value of zero in step 304 without the need for the separate default protected mode indicator 418. The management process 404 writes the identified default protected mode value to the protected mode indicator 206 (step 306).

The method 300 also identifies the default value of the protected diagnostic mode indicator 228 (step 308). The management process 404 may identify this value by reading it from a default protected diagnostic mode indicator 422. Alternatively, the value of the default protected diagnostic mode indicator 422 may be hard-coded into the management process 404. Alternatively, the management process 404 may receive the value of the default protected diagnostic mode indicator from the user 408 through the configuration modification commands 420. The management process 404 writes the identified default value to the protected diagnostic mode indicator 228 (step 310).

The method 300 identifies the value of the boot mode indicator 226 (step 312), which indicates whether the computer system 240 is to boot into the operating system layer 104 (in operating system mode) or the diagnostic layer 216 (in diagnostic mode). The management process 404 may identify this value by, for example, displaying a prompt to the user 408 which asks the user 408 to select diagnostic mode or operating system mode. In response, the user 408 may affirmatively indicate a selection of either diagnostic mode or operating system mode. Furthermore, the management process 404 may identify a default choice (e.g., operating system mode) if the user 408 fails to make a selection within a predetermined amount of time (e.g., ten seconds).

The method 300 determines whether the boot mode indicator 226 indicates that the computer system 240 is to boot into diagnostic mode (step 314). If the computer system 240 is to boot into diagnostic mode, the management process 404 loads the diagnostic tool 218 into the diagnostic layer 216 (step 316). Otherwise, the management process 404 loads the operating system 112 into the operating system layer 104 (step 318). The method 300 boots the computer system 240 with the loaded operating system 112 or diagnostic tool 218 (step 320). Techniques for performing steps 314-320 are well-known to those of ordinary skill in the art.

If the system 240 is operating in operating system mode, in which case the operating system 112 has been loaded into the operating system layer 104, the operating system 112 and applications executing in the application layer 106 are granted or denied access to the computer resources 204a-b and 212 using techniques disclosed in the above-referenced patent application entitled “Computer System Resource Access Control.”

If the diagnostic tool is loaded in step 316, the diagnostic tool 218 may then be used to perform diagnostic operations. Upon completion of such diagnostic operations, the diagnostic tool may be unloaded, the protected diagnostic mode indicator 228 may be cleared, and the operating system 112 may be loaded to operate in (protected or non-protected) non-diagnostic mode.

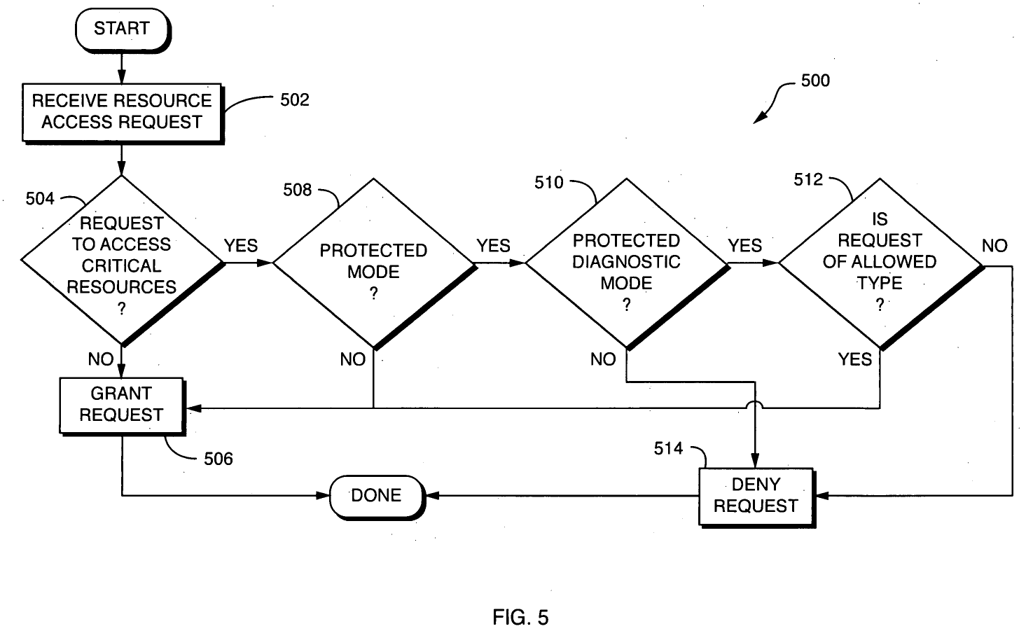

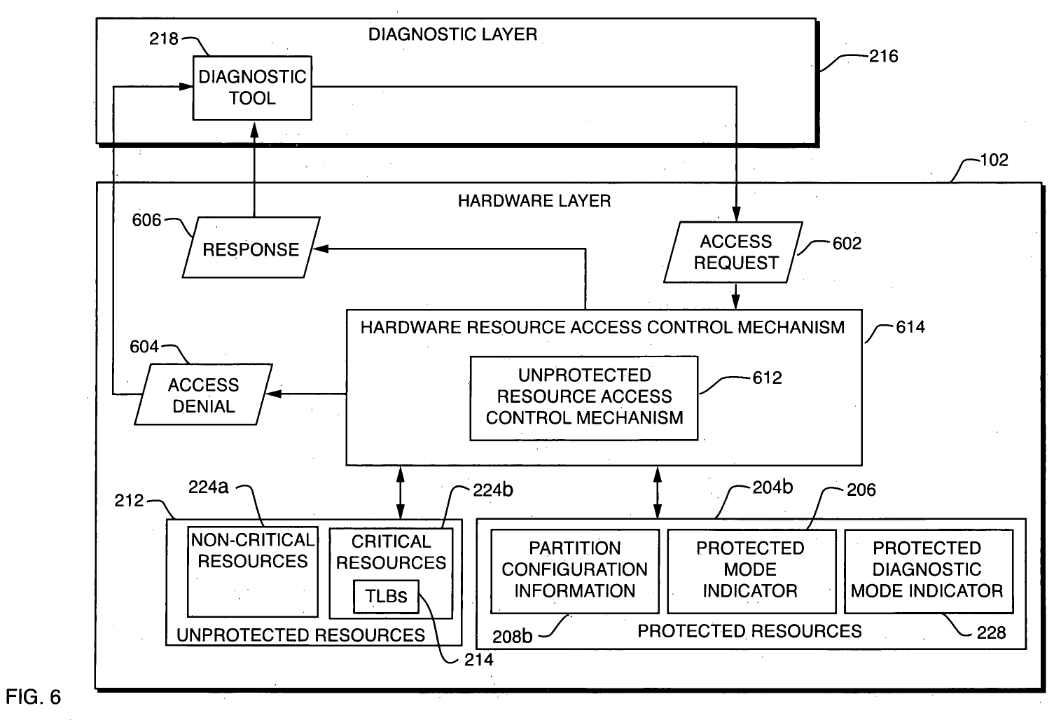

Examples of techniques will now be described for handling resource access requests made by the diagnostic tool 218 when the computer system 240 is operating in diagnostic mode. Referring to FIG. 5, a flowchart is shown of a method 500 that may be performed by the hardware resource access control mechanism 222 to process resource access requests made by the diagnostic tool 218 according to one embodiment of the present invention. Referring to FIG. 6, a block diagram is shown which illustrates the performance of the method 500 by components in the hardware layer 102.

The method 500 receives a request 602 from the diagnostic tool 218 to access unprotected resources 212 in the hardware layer 102 (step 502). In the embodiment illustrated in FIG. 6, such a request is intercepted by the hardware resource access control mechanism 222 in the hardware layer 102. The hardware resource access control mechanism 222 includes an unprotected resource access control mechanism 612, which controls access to the unprotected resources 212. Although not shown in FIG. 6, the hardware resource access control mechanism 222 may also include a protected resource access control mechanism for controlling access to the protected resources, as described in more detail in the above-referenced patent application entitled “Computer System Resource Access Control.”

The method 500 determines whether the request 602 is a request to access one of the critical resources 224b (step 504). If the request 602 is not a request to access one of the critical resources 224a (i.e., if the request is a request to access one of the non-critical resources 224a), the method 500 grants the request 602 (step 506). In other words, all requests by the diagnostic tool 218 to access the non-critical resources 224a are granted.

If the request 602 is a request to access the critical resources 224b, the method 500 determines whether the computer system 240 is operating in protected mode (step 508). If the computer system 240 is not operating in protected mode, the method 500 grants the resource access request 602 (step 506). In other words, when the computer system 240 is operating in non-protected mode, requests by the diagnostic tool 218 to access the critical resources 224b are granted. Therefore, when the computer system 240 is operating in non-protected mode, the diagnostic tool 218 has the same unfettered access to the critical resources-224b as in the system 220 of FIG. 2B, in which the diagnostic tool 218 accesses the unprotected resources 212 directly, without the intervention of the hardware resource access control mechanism 222.

If the request 602 requests access to the critical resources 224b and the computer system 240 is operating in protected mode, the method 500 determines whether the computer system 240 is operating in protected diagnostic mode (step 510). The method 500 may make this determination, for example, by reference to the value of the protected diagnostic mode indicator 228. If the computer system 240 is not operating in protected diagnostic mode, the method 500 denies the resource access request 602 (step 514). In other words, the diagnostic tool 218 is not granted access to the critical resources 224b in protected mode if the computer system 240 is not also operating in protected diagnostic mode.

If the request 602 requests access to the critical resources 224b, and the computer system 240 is operating in both protected mode and protected diagnostic mode, the method 500 determines whether the request 602 is a request to perform an operation of an allowed type (step 512). The unprotected resource access control mechanism 612 may, for example, predefine a set of allowed request types and disallowed request types. For example, “load” requests may be allowed, while “store” requests may be disallowed. Alternatively, both “load” and “store” requests may be allowed. Alternatively, all request types may be disallowed. These particular examples of allowed and disallowed request types are provided merely as illustrations and do not constitute limitations of the present invention.

Although the TLBs 214 are illustrated as an example of the critical resources 224b in FIG. 2C, the TLBs 214 may also be part of the non-critical resources 224a. For example, if both “load” and “store” requests are allowed when the computer system 240 is operating in both protected non-diagnostic mode and protected diagnostic mode, then the TLBs 214 may be considered to be part of the non-critical resources 224a. If “load” requests are allowed and “store” requests are disallowed, then the TLBs may be considered to be part of the non-critical resources 224a for purposes of “load” requests, yet be considered to be part of the critical resources 224b for purposes of “store” requests.

If the request 602 is of an allowed type, the method 500 grants the request (step 506). Otherwise, the method 500 denies the request 602. (step 514). In other words, a request to access critical resources 224b when the computer system 240 is operating in protected mode and protected diagnostic mode are granted only if the request if of an allowed type. If all request types are disallowed, then all requests to access critical resources 224b will be denied when the computer system 240 is operating in protected mode and protected diagnostic mode. The method 500 therefore provides a mechanism to protect the critical resources 224b even from the diagnostic tool 218.

Further protection may be provided by clearing the contents of the critical resources 224b prior to loading the diagnostic tool 218 (i.e., prior to performing step 316 in FIG. 3). By clearing the contents of the critical resources 224b, any previous contents are protected against access by the diagnostic tool 218 even when the computer system 240 is operating in non-protected mode or protected diagnostic mode.

Note that for ease of explanation the embodiment illustrated in FIG. 6 employs both the protected mode indicator 206 and the protected diagnostic mode indicator 228. Alternatively, the protected mode indicator 206 and the protected diagnostic mode indicator 228 may be combined into a single “resource access control mode indicator” which may have a plurality of values corresponding to unprotected mode, protected non-diagnostic mode, and protected diagnostic mode.

Similarly, although the computer system 240 is described as having a distinct “protected diagnostic mode” of operation, the term “protected diagnostic mode” may refer not only to a separate mode of operation, but also to a predetermined privilege level recognized by the computer system 240. For example, as described above, the computer system 240 may recognize a plurality of resource access privilege levels, ranging from a most-privileged level (typically level zero) to a least-privileged level. Programs having the most-privileged privilege level may have access to all resources; including the critical resources 224b. Programs having a lower privilege level may be denied access to the critical resources 224b. Therefore, the “protected diagnostic mode” may be implemented by providing the diagnostic tool 218 with the most-privileged privilege level when it is desired that the diagnostic tool 218 be granted access to the critical resources 224b, while the “protected non-diagnostic mode” may be implemented by providing the diagnostic tool 218 with a lower privilege level when it is desired that the diagnostic tool 218 be denied access to the critical resources 224b.

Furthermore, the division of the unprotected resources into non-critical resources 224a and critical resources 224b is illustrated and described merely for purposes of example and does not constitute a limitation of the present invention. Alternatively, for example, all of the unprotected resources 212 may be considered to be critical resources 224b, in which case step 504 of method 500 may be omitted.

In addition, the division of resource access requests into allowed and disallowed types is illustrated and described merely for purposes of example and does not constitute a limitation of the present invention. Alternatively, for example, all request types may be considered to be disallowed request types, in which case step 512 of method 500 may be omitted, and all requests to access the critical resources 224b when the computer system 240 is operating in protected mode and protected diagnostic mode may be denied.

Although in the examples described above, the computer system 240 may be configured to operate in either protected mode or non-protected mode, this is not a requirement of the present invention. Rather, techniques disclosed herein may be applied to protect critical resources 224b against access by the diagnostic tool 218 even in a system which has no protected mode and unprotected mode. For example, step 508 may be omitted from the method 500 shown in FIG. 5, and steps 504, 510, and 512 (or a subset thereof) may be performed to determine whether to grant or deny access to the critical resources 224b.

One advantage of techniques disclosed herein is that they allow resources, such as the translation lookaside buffers 214, caches, and other memory arrays to be protected against being accessed even by the diagnostic tool 218, which in prior art systems had unrestricted access to resources in the hardware layer 102. As described above, although it may be desirable to provide the diagnostic tool 218 with such unrestricted access in some circumstances, it may also be desirable to deny such access to the diagnostic tool 218 in other circumstances. The techniques disclosed herein allow access to the critical resources 224b by the diagnostic tool 218 to be granted selectively, thereby enabling such access to be granted when desirable and denied when desirable. Such flexibility allows increased security of the critical resources 224b to be obtained while retaining the ability to use the diagnostic tool 218 for its intended purposes.

Another advantage of techniques disclosed herein is that they may be used in conjunction with conventional resource access control mechanisms (such as those based on privilege levels) and the mechanisms for protecting access to the protected resources 204a-b that are described in the above-referenced patent application entitled “Computer System Resource Access Control.” The techniques disclosed herein may, therefore, advantageously provide control over access by the diagnostic tool 218 to the critical resources 224b without interfering with other resource access control mechanisms present within the computer system 240.

Another advantage of techniques disclosed herein is that they enable an additional level of resource protection to be added to a computer system without requiring the diagnostic tool 218 to be modified. The techniques disclosed herein may, in other words, be implemented in a manner that is transparent to the diagnostic tool 218. Such techniques thereby avoid the added expense and time that would be required to modify the diagnostic tool 218 to work in conjunction with a protection scheme that protects the critical resources 224b in the manner described above. Furthermore, because such techniques are implemented independently of the diagnostic tool 218, such techniques may protect the desired resources regardless of the manner in which the diagnostic tool 218 is implemented.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although particular examples of the unprotected resources 212 are provided above, the techniques disclosed herein may be used to protect any kind of resources. For example, the techniques disclosed herein may be used to protect partition-related system configuration information, regions of memory, I/O controllers, processor configuration information, testing/diagnostic resources, and registers. Although the unprotected resources 212 in the examples above are located in the hardware layer 102, this is not a requirement of the present invention. Rather, the techniques disclosed herein may be used to protect resources located in the hardware interface layer 202 or in any component or layer of a computer system. Similarly, although access control is performed by the hardware resource access control mechanism 222 in the hardware layer 102 in the examples above, this is not a requirement of the present invention. Rather, access control may be performed by any component or combination of components in a computer system. Furthermore, although the IA-64 PAL and SAL are described herein as examples of the hardware interface layer 202, the techniques disclosed herein may be implemented in conjunction with any computer architecture.

Although the examples disclosed above provide protection against accessing of the critical resources 224b by the diagnostic tool 218, the techniques disclosed herein are not limited to use in conjunction with diagnostic tools. There are, for example, other tools that typically have direct access to the unprotected resources 212 and to which the techniques disclosed herein may be applied. For example, an “error injector” is an example of a program that seeds errors into a cache to enable the operating system's error recovery capabilities to be tested. Similarly, an application or operating system may store secret information, such as encryption keys, in the critical resources 224b so that viruses cannot gain access to critical data. Those having ordinary skill in the art will appreciate how to apply the techniques disclosed herein to such programs.

The management process 404 is described herein as performing a variety of functions. The management process 404 may alternatively be implemented, for example, as a management processor. A management processor is a processor commonly used in servers to perform system management functions such as booting up the server with an appropriate operating system.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method for use in a computer system including a plurality of resources, the plurality of resources including protected resources and unprotected resources, the unprotected resources including critical resources and non-critical resources, the method comprising steps of:
(A) receiving a request from a software program to access a specified one of the unprotected resources;
(B) granting the request if the computer system is operating in a non-protected mode of operation; and
(C) if the computer system is operating in a protected mode of operation, performing a step of:
(1) denying the request if the computer system is not operating in a protected diagnostic mode of operation.

2. The method of claim 1, wherein step (C) further comprises a step of:
(C)(2) granting the request if the computer system is operating in the protected diagnostic mode of operation.

3. The method of claim 1, wherein step (C) further comprises steps of:
(C)(2) granting the request if the computer system is operating in the protected diagnostic mode of operation and the request is a request to perform an operation in a predetermined set of allowed operations; and
(C)(3) denying the request if the computer system is operating in the protected diagnostic mode of operation and the request is a request to perform an operation not in the predetermined set of allowed operations.

4. The method of claim 3, wherein the predetermined set of allowed operations includes hardware load operations and hardware store operations.

5. The method of claim 3, wherein the predetermined set of allowed operations includes hardware load operations and does not include hardware store operations.

6. The method of claim 1, wherein the software program comprises an operating system.

7. The method of claim 1, wherein the software program comprises an application program.

8. The method of claim 1, wherein the software program comprises a diagnostic tool.

9. The method of claim 1, wherein the specified one of the unprotected resources comprises a memory location.

10. The method of claim 1, wherein the specified one of the unprotected resources comprises a translation lookaside buffer.

11. A device for use in a computer system including a plurality of resources, the plurality of resources including protected resources and unprotected resources, the unprotected resources including critical resources and non-critical resources, the device comprising:
means for receiving a request from a software program to access a specified one of the unprotected resources;
first access control means for granting the request if the computer system is operating in a non-protected mode of operation; and
second access control means for denying the request if the computer system is operating in a protected mode of operation and the computer system is not operating in a protected diagnostic mode of operation.

12. The device of claim 11, wherein the second access control means comprises means for granting the request if the computer system is operating in the protected diagnostic mode of operation.

13. The device of claim 11, wherein the second access control means further comprises:
means for granting the request if the computer system is operating in the protected diagnostic mode of operation and the request is a request to perform an operation in a predetermined set of allowed operations; and
means for denying the request if the computer system is operating in the protected diagnostic mode of operation and the request is a request to perform an operation not in the predetermined set of allowed operations.

14. The method of claim 1, wherein the software program comprises a diagnostic tool.

15. The method of claim 1, wherein the specified one of the unprotected resources comprises a memory location.

16. A computer system comprising:
a plurality of resources including protected resources and unprotected resources, the unprotected resources including critical resources and non-critical resources;
a software program to make a request to access a specified one of the unprotected resources; and
a hardware resource access control mechanism to receive the request, the hardware resource access control mechanism comprising:
an unprotected resource access control mechanism to grant the request if the computer system is operating in a non-protected mode of operation and to deny the request if the computer system if operating in a protected mode of operation and is not operating in a protected diagnostic mode of operation.

17. The device of claim 16, wherein the unprotected resource access control mechanism is configured and arranged to grant the request if the computer system is operating in the protected diagnostic mode of operation.

18. The device of claim 16, wherein the unprotected resource access control mechanism is configured and arranged to grant the request if the computer system is operating in the protected diagnostic mode of operation and the request is a request to perform an operation in a predetermined set of allowed operations, and to deny the request if the computer system is operating in the protected diagnostic mode of operation and the request is a request to perform an operation not in the predetermined set of allowed operations.

19. The device of claim 16, wherein the software program comprises a diagnostic tool.

20. The device of claim 16, wherein the specified one of the unprotected resources comprises a memory location.

21. The device of claim 16, wherein the specified one of the unprotected resources comprises a translation lookaside buffer.

22. A computer-implemented method for use in a computer system including a diagnostic tool and a hardware layer including a plurality of resources, the method comprising steps of:
(A) receiving a request from the diagnostic tool to access a specified one of the plurality of resources; and
(B) denying the request if the computer system is not operating in a protected diagnostic mode of operation.

23. The method of claim 22, further comprising a step of:
(C) granting the request if the computer system is operating in the protected diagnostic mode of operation.

24. The method of claim 22, wherein the request comprises a hardware load request.

25. The method of claim 22, wherein the request comprises a hardware store request.

26. The method of claim 22, wherein the specified one of the plurality of resources comprises a memory location.

27. The method of claim 22, wherein the specified one of the plurality of resources comprises a translation lookaside buffer.

28. A device for use in a computer system including a diagnostic tool and a hardware layer including a plurality of resources, the device comprising:
means for receiving a request from the diagnostic tool to access a specified one of the plurality of resources; and
means for denying the request if the computer system is not operating in a protected diagnostic mode of operation.

29. The device of claim 28, further comprising:
means for granting the request if the computer system is operating in the protected diagnostic mode of operation.

30. The device of claim 28, wherein the request comprises a hardware load request.

31. The device of claim 28, wherein the request comprises a hardware store request.

32. The device of claim 28, wherein the specified one of the plurality of resources comprises a memory location.

33. The device of claim 28, wherein the specified one of the plurality of resources comprises a translation lookaside buffer.

34. A computer system comprising:
a hardware layer including a plurality of resources;
a diagnostic tool to make a request to access a specified one of the plurality of resources;
a hardware resource access control mechanism to receive the request, the hardware resource access control mechanism comprising an unprotected resource access control mechanism to deny the request if the computer system is not operating in a protected diagnostic mode of operation.

35. The device of claim 34, wherein the unprotected resource access control mechanism is configured and arranged to grant the request if the computer system is operating in the protected diagnostic mode of operation.

36. The device of claim 34, wherein the request comprises a hardware load request.

37. The device of claim 34, wherein the request comprises a hardware store request.

38. The device of claim 34, wherein the specified one of the plurality of resources comprises a memory location.

39. The device of claim 34, wherein the specified one of the plurality of resources comprises a translation lookaside buffer.
